(19) United States
(12) Patent Application Publication
(10) Pub. No.: US 2006/0139551 A1
(43) Pub. Date: Jun. 29, 2006

(54) Display device

(76) Inventor: Yohei Kimura, Ishikawa-gun (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/305,288

(22) Filed: Dec. 19, 2005

(30) Foreign Application Priority Data
Dec. 27, 2004 (JP) 2004-378261

(51) Int. Cl. G02F 1/1345

(52) U.S. Cl. 349/149

(57) ABSTRACT

A display device includes an active area that is composed of a plurality of pixels and a plurality of signal supply wiring lines that supply driving signals to the pixels, a plurality of input sections that are disposed outside the active area and function to input the driving signals that are to be supplied to the signal supply wiring lines, and a plurality of connection wiring lines that connect the signal supply wiring lines and the input sections. Mutually neighboring first connection wiring line and second connection wiring line of the connection wiring lines are disposed in different layers via an insulating layer.

### CROSS-REFERENCE TO RELATED APPLICATIONS

This application is based upon and claims the benefit of priority from prior Japanese Patent Application No. 2004-378261, filed Dec. 27, 2004, the entire contents of which are incorporated herein by reference.

### BACKGROUND OF THE INVENTION

1. Field of the Invention

The present invention relates generally to a display device, and more particularly to a display device including wiring lines that are arranged with high density on an outside peripheral part of an active area.

2. Description of the Related Art

A display device, such as a liquid crystal display device, includes an active area that is composed of pixels arranged in a matrix. The active area includes a plurality of scan lines extending along rows of the pixels, a plurality of signal lines extending along columns of the pixels, switching elements that are disposed near intersections between the scan lines and signal lines, and pixel electrodes that are connected to the switching elements. The scan lines and signal lines are led out to an outside peripheral part of the active area.

In recent years, in order to meet a demand for an increase in number of pixels due to higher definition and a decrease in size of a picture-frame-like part, it is necessary to arrange the wiring lines, such as scan lines and signal lines, with small line widths and small inter-line gaps in the active area and in the outside peripheral part of the active area. However, there are restrictions to the decrease in line widths and inter-line gaps, in consideration of the precision in patterning and the manufacturing yield. It is thus very difficult to form wiring lines with high density in a limited area, while suppressing occurrence of wiring defects such as short-circuit between wiring lines or breakage of wiring lines.

Jpn. Pat. Appln. KOKAI Publication No. 2002-268575 and Jpn. Pat. Appln. KOKAI Publication No. 2002-258310 disclose techniques for achieving a decrease in size of a picture-frame-like part and an increase in wiring density.

### BRIEF SUMMARY OF THE INVENTION

The present invention has been made in consideration of the above-described problem, and the object of the invention is to provide a display device that can achieve a decrease in size of a picture-frame-like part and an increase in wiring density, while preventing occurrence of defects in a reliability test and a decrease in manufacturing yield.

According to an aspect of the present invention, there is provided a display device comprising: an active area that is composed of a plurality of pixels and a plurality of signal supply wiring lines that supply driving signals to the pixels; a plurality of input sections that are disposed outside the active area and function to input the driving signals that are to be supplied to the signal supply wiring lines; and a plurality of connection wiring lines that connect the signal supply wiring lines and the input sections, wherein mutually neighboring first connection wiring line and second connection wiring line of the connection wiring lines are disposed in different layers via an insulating layer.

The present invention can provide a display device that can achieve a decrease in size of a picture-frame-like part and an increase in wiring density, while preventing occurrence of defects in a reliability test and a decrease in manufacturing yield.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the structure of a liquid crystal display panel of a liquid crystal display device according to an embodiment of the present invention;

FIG. 2 schematically shows an example of the structure of a first connection section in the liquid crystal display panel shown in FIG. 1;

FIG. 3 is a view for explaining an example of arrangement of neighboring first and second connection wiring lines;

FIG. 4 schematically shows a layout of scan lines, connection wiring lines and input sections in Embodiment 1;

FIG. 5 is a cross-sectional view, taken along line A-A in FIG. 4, which schematically shows a cross-sectional structure of a jumper section that connects the scan line and connection wiring line;

FIG. 6 is a cross-sectional view, taken along line B-B in FIG. 4, which schematically shows a cross-sectional structure of the connection wiring lines and input sections in a state in which a driving IC chip is connected to the input sections;

FIG. 7 schematically shows a layout of scan lines, connection wiring lines and input sections in Embodiment 2;

FIG. 8 is a cross-sectional view, taken along line C-C in FIG. 7, which schematically shows a cross-sectional structure of the connection wiring lines and input sections in a state in which a driving IC chip is connected to the input sections;

FIG. 9A schematically shows a layout of scan lines, connection wiring lines and input sections in Embodiment 3;

FIG. 9B schematically shows a layout of scan lines, connection wiring lines and input sections in Embodiment 3;

FIG. 10 is a cross-sectional view, taken along line D-D in FIG. 9A, which schematically shows a cross-sectional structure of a jumper section that connects the scan line and connection wiring line;

FIG. 11 is a cross-sectional view, taken along line E-E in FIG. 9A, which schematically shows a cross-sectional structure of the connection wiring lines and input sections in a state in which a driving IC chip is connected to the input sections; and

FIG. 12 is a view for explaining the relationship in the ratio of line width to sheet resistance between neighboring connection wiring lines.

### DETAILED DESCRIPTION OF THE INVENTION

Display devices according to embodiments of the present invention will now be described.

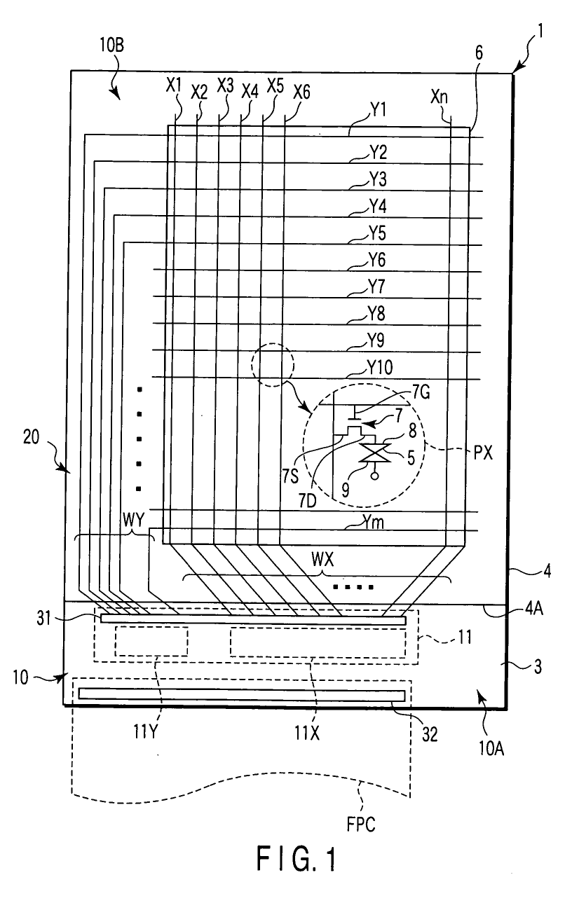

As is shown in FIG. 1, a liquid crystal display device, which is an example of a display device, includes a substantially rectangular, planar liquid crystal display panel 1. The liquid crystal display panel 1 comprises a pair of substrates, that is, an array substrate 3 and a counter-substrate 4, and a liquid crystal layer 5 that is interposed as an optical modulation layer between the pair of substrates. The liquid crystal display panel 1 includes a substantially rectangular active area 6 that displays an image. The active area 6 is composed of, e.g. a plurality of pixels PX that are arranged in a matrix, and a plurality of signal supply wiring lines that supply driving signals to the pixels PX.

The array substrate 3 includes, as the signal supply wiring lines arranged in the active area 6, a plurality of scan lines Y (1, 2, 3, . . . , m) that extend in a row direction of the pixels PX, and a plurality of signal lines X (1, 2, 3, . . . , n) that extend in a column direction of the pixels PX. The scan lines Y and signal lines X are disposed in different layers via an insulating layer. In addition to the scan lines Y and signal lines X, the array substrate 3 includes, in the active area 6, switching elements 7 that are disposed in the respective pixels PX near intersections between scan lines Y and signal lines X, and pixel electrodes 8 that are connected to the switching elements 7.

The switching element 7 is formed of, e.g. a thin-film transistor (TFT). The switching element 7 has a gate electrode 7G that is electrically connected to the associated scan line Y (or formed integral with the scan line). The switching element 7 has a source electrode 7S that is electrically connected to the associated signal line X (or formed integral with the signal line). The switching element 7 has a drain electrode 7D that is electrically connected to the pixel electrode 8 of the associated display pixel PX (or formed integral with the pixel electrode).

In the case of a transmissive liquid crystal display device that selectively transmits backlight to display an image, the pixel electrode 8 is formed of a light-transmissive metallic material such as indium tin oxide (ITO). In the case of a reflective liquid crystal display device that selectively reflects ambient light from the counter-substrate 4 side to display an image, the pixel electrode 8 is formed of a light-reflective metallic material such as aluminum (Al).

The counter-substrate 4 includes a counter-electrode 9 that is common to all the pixels PX in the active area 6. The counter-electrode 9 is formed of a light-transmissive metallic material such as ITO. The array substrate 3 and counter-substrate 4 are disposed such that the pixel electrodes 8 of all pixels PX are opposed to the counter-electrode 9, and a gap is provided therebetween. The liquid crystal layer 5 is formed of a liquid crystal composition that is sealed in the gap between the array substrate 3 and counter-substrate 4.

In a color display type liquid crystal display device, the liquid crystal display panel 1 includes a plurality of kinds of pixels, for instance, a red pixel that displays red (R), a green pixel that displays green (G), and a blue pixel that displays blue (B). Specifically, the red pixel includes a red color filter that passes light with a principal wavelength of red. The green pixel includes a green color filter that passes light with a principal wavelength of green. The blue pixel includes a blue color filter that passes light with a principal wavelength of blue. These color filters are disposed on a major surface of the array substrate 3 or counter-substrate 4.

The liquid crystal display panel 1 includes a connection wiring line group 20, a first connection section 31 and a second connection section 32 on an outer peripheral part 10 that is located outside the active area 6. The first connection section 31 is connectable to a driving IC chip 11 that functions as a signal supply source that supplies driving signals to the signal supply wiring lines. The second connection section 32 is connectable to a flexible printed circuit FPC that functions as a signal supply source. In the example shown in FIG. 1, the first connection section 31 and second connection section 32 are disposed on an extension part 10A of the array substrate 3 that extends outward from an end portion 4A of the counter-substrate 4. The driving IC chip 11 and first connection section 31 are electrically and mechanically connected via, e.g. an anisotropic electrically conductive film.

The driving IC chip 11 that is mounted on the first connection section 31 of the liquid crystal display panel 1 includes at least a part of a signal line driving section 11X that supplies driving signals (video signals) to the signal lines X in the active area 6, and at least a part of a signal line driving section 11Y that supplies driving signals (scan signals) to the scan lines Y in the active area 6.

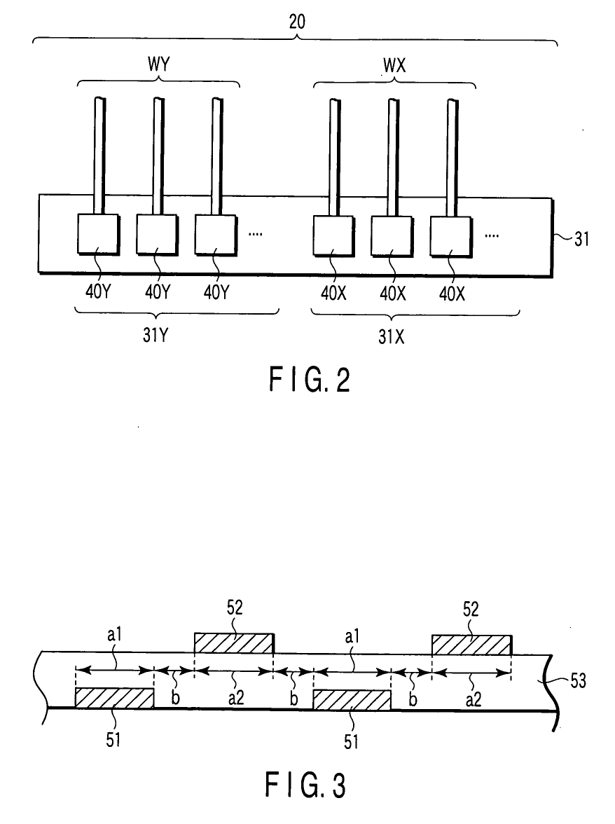

The first connection section 31 and second connection section 32 include a plurality of input sections for inputting driving signals that are to be supplied to the signal supply wiring lines. In particular, the first connection section 31, as shown in FIG. 2, includes input sections 40, the number of which is equal to or greater than the number of signal supply wiring lines. Specifically, the first connection section 31 includes a Y-connection section 31Y that is connected in association with the scan line driving section 11Y of the driving IC chip 11, and an X-connection section 31X that is connected in association with the signal line driving section 11X of the driving IC chip 11. The Y-connection section 31Y includes input sections 40Y, the number of which is equal to or greater than the number of scan lines Y. The X-connection section 31X includes input sections 40X, the number of which is equal to or greater than the number of signal lines X.

The connection wiring line group 20 comprises a plurality of connection wiring lines that connect the signal supply lines and the input sections 40. Specifically, the connection wiring line group 20 comprises connection wiring lines W, the number of which is equal to or greater than the number of signal supply wiring lines. The connection wiring line group 20 includes connection wiring lines WY that connect the input sections 40Y of the Y-connection section 31Y to the scan lines Y, and connection wiring lines WX that connect the input sections 40X of the X-connection section 31X to the signal lines X. In the example shown in FIG. 1, the connection wiring lines WY are disposed on one end side 10B of the outer peripheral part 10.

With this structure, the scan line driving section 11Y is electrically connected to the scan lines Y (1, 2, 3, . . . ) via the connection wiring lines WY. Specifically, driving signals that are output from the scan line driving section 11Y are delivered to the input sections 40Y of the Y-connection section 31Y of the first connection section 31, and are supplied to the associated scan lines Y (1, 2, 3, . . . ) via the connection wiring lines WY. The switching elements 7 that are included in the pixel PX on each row are ON/OFF controlled by the scan signal that is supplied from the associated scan line Y.

On the other hand., the signal line driving section 11X is electrically connected to the signal lines X (1, 2, 3, . . . ) via the connection wiring lines WX. Specifically, driving signals that are output from the signal line driving section 11X are delivered to the input sections 40X of the X-connection section 31X of the first connection section 31, and are supplied to the associated signal lines X (1, 2, 3, . . . ) via the connection wiring lines WX. The switching elements 7 that are included in the pixels PX on each column write the video signal, which is supplied from the associated signal line X, in the pixel electrodes 8, at a timing when these switching elements 7 are turned on.

As regards the display device with the above-described structure, in recent years, in order to meet a demand for an increase in number of pixels due to higher definition and for a decrease in size of a picture-frame-like part, it is necessary to arrange the wiring lines with high density in a limited picture-frame-shaped space (outer peripheral part 10), while suppressing occurrence of short-circuit between wiring lines or breakage of wiring lines.

To meet the demand, in the display device according to this embodiment, the mutually neighboring connection wiring liens are disposed in different layers via an insulating layer. Specifically, as shown in FIG. 3, neighboring first connection wiring lines 51 and second connection wiring lines 52, which are included in the connection wiring lines, are disposed in different metal layers via an insulating layer 53. With this structure, it becomes possible to realize a decrease in size of the picture-frame-like part and an increase in number of pixels.

Assume now that the line width of the first connection wiring line 51 is a1, the line width of the second connection wiring line 52 is a2, and the gap between these connection wiring lines is b. In this case, the pitch of connection wiring lines disposed in the same layer, for example, the pitch of first connection wiring lines 51, can be set in a range of between (a1+b) and (a1+a2+2*b). Compared to the case where all connection wiring lines are disposed in the same layer with the gap b, it is possible to realize a smaller size of the picture-frame-like part and a smaller number of pixels.

While realizing a decrease in the picture-frame-shaped space and an increase in density of connection wiring lines disposed on the picture-frame-like part, it is possible to secure an enough space to prevent occurrence of short-circuit between neighboring connection wiring lines and an enough line width to prevent occurrence of breakage of each connection wiring line. Therefore, it is possible to provide a display device that can prevent occurrence of defects in a reliability test and can achieve a high manufacturing yield.

In particular, in the layout in which scan signals are supplied from one side of the active area 6 as shown in FIG. 1, the density of connection wiring lines WY that are connected to the scan lines Y can be increased, and the size of the picture-frame-like part on one end side 10B of the outer peripheral part 10 can be reduced. In a layout in which scan signals are supplied from both sides of the active area 6, the size of the picture-frame-like parts on both sides of the outer peripheral part 10 can be reduced.

The first connection wiring lines 51 and second connection wiring lines 52, which are disposed in the two different layers, can be formed at the same time in the step of patterning metal materials of various lines and electrodes in the active area 6. For example, the first connection wiring lines 51 can be formed in the same fabrication step as the scan lines Y, and the second connection wiring lines 52 can be formed in the same fabrication step as the signal lines X. Thus, no additional fabrication step is required to form the connection wiring line group of the multi-layer structure, and no deterioration occurs in the manufacturing yield.

In short, the neighboring first connection wiring lines 51 and second connection wiring lines 52 can be disposed with a gap smaller than the limit of resolution in the patterning step of these wiring lines. When the first connection wiring lines 51 and second connection wiring lines 52 are viewed in plan (i.e. in the plane of the array substrate), these wiring lines 51 and 52 are formed without overlapping. However, even if these wiring lines appear to overlap in plan because of the disposition of these wiring lines in the small-sized picture-frame-like region, no short-circuit occurs between the connection wiring lines by virtue of the insulating layer 53 lying between the wiring lines.

Next, specific embodiments of the invention are described. In the embodiments, it is assumed that the signal supply lines are scan lines Y, the signal supply source is the scan line driving section 11Y of the driving IC chip 11 that is mounted on the outer peripheral part 10, and each of the input sections 40Y of the Y-connection section 31Y and the associated scan line Y are connected by the wiring line WY.

### Embodiment 1

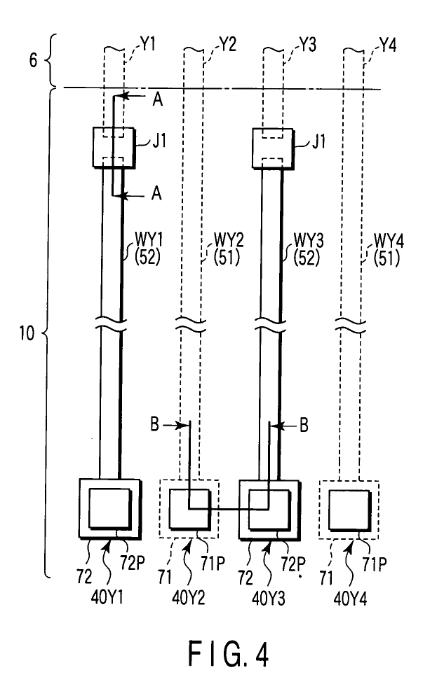

As is shown in FIG. 4, scan lines Y (1, 2, 3, . . . are disposed in the active area 6. The input sections 40Y (1, 2, 3, . . . ) and the connection wiring lines WY (1, 2, 3, . . . ), which connect the scan lines Y and the associated input sections 40Y, are disposed in the outer peripheral part 10. In the example shown in FIG. 4, even-numbered connection wiring lines WY (2, 4, . . . ) are disposed in the same layer as the scan lines Y. Odd-numbered connection wiring lines WY (1, 3, . . . ) are disposed in a layer different from the layer of the scan lines Y, for example, in the same layer as signal lines X (not shown). Needless to say, all scan lines Y in the active layer 6 are disposed in the same layer.

The connection wiring lines WY (2, 4, . . . ) are disposed in a lower layer than the connection wiring lines WY (1, 3, . . . ), and the insulating layer lies between the connection wiring lines WY (2, 4, . . . ) and the connection wiring lines WY (1, 3, . . . ) Specifically, the connection wiring lines WY (2, 4, . . . ) correspond to the first connection wiring lines 51 shown in FIG. 3, and the connection wiring lines WY (1, 3, . . . ) correspond to the second connection wiring lines 52. In short, the even-numbered connection wiring lines WY (2, 4, . . . ) and the odd-numbered connection wiring lines WY (1, 3, . . . ), which neighbor the even-numbered connection wiring lines WY (2, 4, . . . ), are disposed in different layers.

The first connection wiring lines 51 are integrally formed with the associated scan lines Y that are disposed in the same layer. Thereby, the first connection wiring lines 51 are electrically connected to the associated scan lines Y. On the other hand, the second connection wiring lines 52 are electrically connected via first jumper sections J1 to the associated scan lines Y that are disposed in the different layer. The jumper section corresponds to a connection section for non-continuous wiring lines. The same applies to jumper sections to be described below.

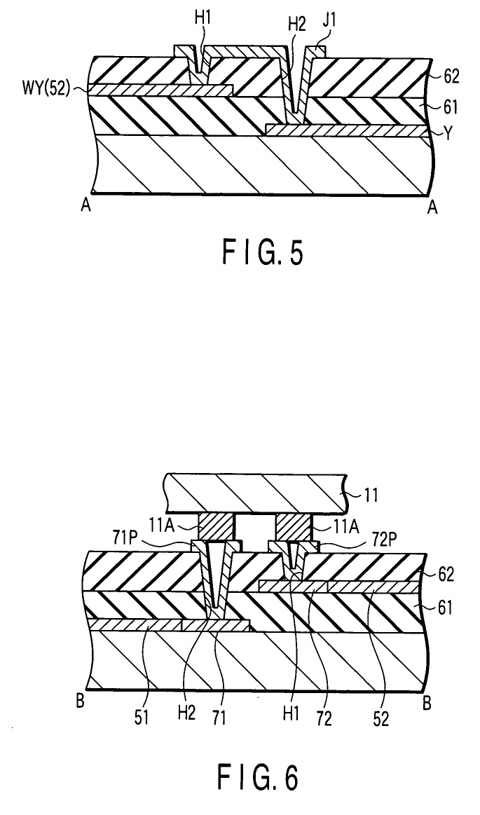

As is shown in FIG. 5, the second connection wiring line 52 is disposed on a first insulation layer 61 that covers the scan line Y. The first jumper section J1 is disposed on a second insulation layer 62 that covers the second connection wiring line 52. The first jumper section J1 is electrically connected to the second connection wiring line 52 via a first contact hole H1 that penetrates the second insulation layer 62 down to the second connection wiring line 52, and is also electrically connected to the scan line Y via a second contact hole H2 that penetrates the first insulation layer 61 and second insulation layer 62 down to the scan line Y. The first jumper section J1 can be formed at the same time in the step of forming the metal pattern in the active area 6. For example, the first jumper section J1 can be formed of the same material as the pixel electrode 8. Thus, no additional fabrication step is required to form the first jumper section J1.

The input section 40Y (2, 4, . . . ) corresponding to the first connection wiring line 51 is disposed in the same layer as the first connection wiring line 51, and includes a first input terminal 71 that is connected to the first connection wiring line 51. The input section 40Y (1, 3, . . . ) corresponding to the second connection wiring line 52 is disposed in the same layer as the second connection wiring line 52, and includes a second input terminal 72 that is connected to the second connection wiring line 52. The first connection wiring line 51 and first input terminal 71 can be formed in the same step using the same metal material. In this example, the first connection wiring line 51 and first input terminal 71 are integrally formed. Similarly, the second connection wiring line 52 and second input terminal 72 can be formed in the same step using the same metal material. In this example, the second connection wiring line 52 and second input terminal 72 are integrally formed.

The input sections 40Y (1, 2, 3, 4, . . . ) include a plurality of input pads that are connected to output terminals of the driving IC chip 11. Specifically, as shown in FIG. 6, the input section 40Y (2, 4, . . . ) that corresponds to the first connection wiring line 51 includes an input pad 71P. The input pad 71P is electrically connected to the first input terminal 71 via a second contact hole H2 that penetrates the first insulation layer 61 and second insulation layer 62 down to the first input terminal 71. The input section 40Y (1, 3, . . . ) that corresponds to the second connection wiring line 52 includes an input pad 72P. The input pad 72P is electrically connected to the second input terminal 72 via a first contact hole H1 that penetrates the second insulation layer 62 down to the second input terminal 72. The input pads 71P and 72P can be formed at the same time in the step of forming the metal pattern in the active area 6. For example, the input pads 71P and 72P can be formed of the same material as the pixel electrode 8.

Thereby, driving signals, which are output from the output terminals 11A of the driving IC chip 11, can be supplied to the first connection wiring line 51 via the input section 40Y including the input pad 71P and first input terminal 71, and to the second connection wiring line 52 via the input section 40Y including the input pad 72P and second input terminal 72.

According to the above-described Embodiment 1, it is possible to secure the inter-line gaps that can suppress occurrence of short-circuit between connection wiring lines disposed on the outer peripheral part, and to secure the line width that can suppress occurrence of breakage of each connection wiring line. In addition, it is possible to reduce the size of the outer peripheral part and to increase the density of connection wiring lines. Therefore, it is possible to achieve a decrease in size of the picture-frame-like region and an increase in wiring density, while preventing occurrence of defects in a reliability test and a decrease in manufacturing yield.

In the above-described Embodiment 1, no jumper section is present on a wiring line extending via the first connection wiring line 51 between the associated scan line and the input section, and a single jumper section (first jumper section) is present on a wiring line extending via the second connection wiring line 52. It is thus desirable to choose a material with relatively low sheet resistance as the material of the jumper section. For example, the jumper section may be formed of aluminum that is a metal material with relatively low resistance, of which the pixel electrodes 8 are formed in the reflective liquid crystal display. In addition, the jumper section may be formed of a low-resistance metallic material in a fabrication step different from the step of forming metal patterns in the active area 6.

### Embodiment 2

In Embodiment 2, the structural parts common to those in Embodiment 1 are denoted by like reference numerals, and a detailed description thereof is omitted.

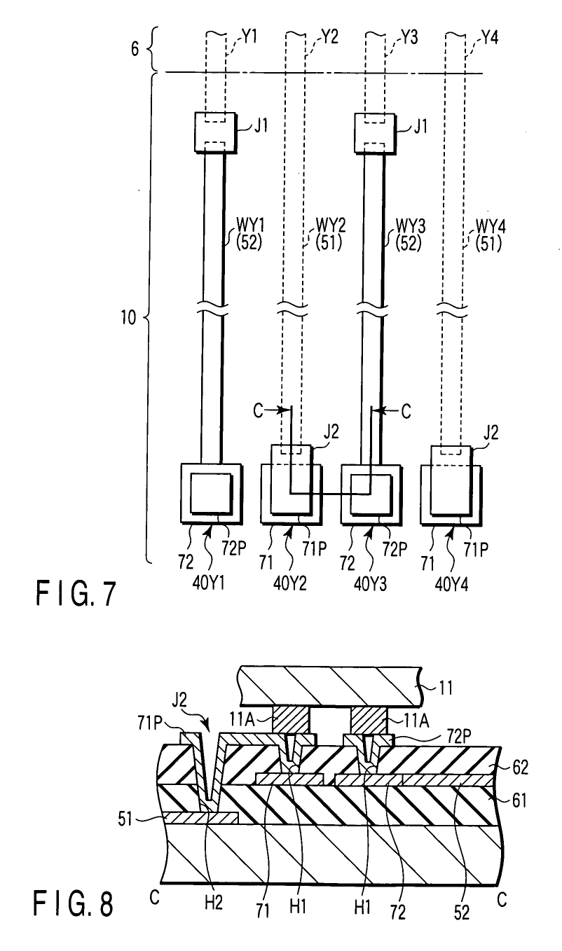

As is shown in FIG. 7, scan lines Y (1, 2, 3, . . . ) are disposed in the active area 6. The input sections 40Y (1, 2, 3, . . . ) and the connection wiring lines WY (1, 2, 3, . . . ), which connect the scan lines Y and the associated input sections 40Y, are disposed in the outer peripheral part 10. In the example shown in FIG. 7, even-numbered connection wiring lines WY (2, 4, . . . ) are disposed in the same layer as the scan lines Y, and correspond to the first connection wiring lines 51 shown in FIG. 3. Odd-numbered connection wiring lines WY (1, 3, . . . ) are disposed in a layer different from the layer of the scan lines Y, and correspond to the second connection wiring lines 52 shown in FIG. 3. In short, the even-numbered connection wiring lines WY (2, 4, . . . ) and the odd-numbered connection wiring lines WY (1, 3, . . . ), which neighbor the even-numbered connection wiring lines WY (2, 4, . . . ), are disposed in different layers.

The first connection wiring lines 51 are integrally formed with the associated scan lines Y that are disposed in the same layer. Thereby, the first connection wiring lines 51 are electrically connected to the associated scan lines Y. On the other hand, the second connection wiring lines 52 are electrically connected via first jumper sections J1 to the associated scan lines Y that are disposed in the different layer. The connection structure between the second connection wiring line 52 and the associated scan line Y via the first jumper section J1 is the same as shown in FIG. 5.

The input section 40Y (2, 4, . . . ) that corresponds to the first connection wiring line 51 includes a first input terminal 71 that is disposed in a layer different from the layer of the first connection wiring line 51 and is connected to the first connection wiring line 51 via a second jumper section J2. Like Embodiment 1, the input section 40Y (1, 3, . . . ) corresponding to the second connection wiring line 52 includes a second input terminal 72 that is disposed in the same layer as the second connection wiring line 52 and is connected to the second connection wiring line 52. The first input terminal 71 and second input terminal 72, which constitute the input sections 40Y, can be formed in the same step using the same metal material. In this example, the first input terminal 71 and second input terminal 72 are formed at the same time as the second connection wiring line 52. In this case, the second input terminal 72 and second connection wiring line 52 are integrally formed. Thus, the first input terminal 71 and second input terminal 72 are disposed in the same layer.

The input sections 40Y (1, 2, 3, 4, . . . ) include a plurality of input pads that are connected to output terminals 11A of the driving IC chip 11. Specifically, as shown in FIG. 8, the input section 40Y (2, 4, . . . ) that corresponds to the first connection wiring line 51 includes an input pad 71P. The input pad 71P is electrically connected to the first connection wiring line 51 via a second contact hole H2 that penetrates the first insulation layer 61 and second insulation layer 62 down to the first connection wiring line 51, and is also electrically connected to the first input terminal 71 via a first contact hole H1 that penetrates the second insulation layer 62 down to the first input terminal 71. In this case, the input pad 71P also functions as the second jumper section J2. On the other hand, the input section 40Y (1, 3, . . . ) that corresponds to the second connection wiring line 52 includes an input pad 72P. The structure of the input pad 72P is the same as described in connection with Embodiment 1. The input pads 71P and 72P can be formed at the same time in the step of forming the metal pattern in the active area 6. For example, the input pads 71P and 72P can be formed of the same material as the pixel electrode 8.

Thereby, driving signals, which are output from the output terminals 11A of the driving IC chip 11, can be supplied to the first connection wiring line 51 via the input section 40Y including the input pad 71P and first input terminal 71, and to the second connection wiring line 52 via the input section 40Y including the input pad 72P and second input terminal 72.

According to the above-described Embodiment 2, the same advantages as in Embodiment 1 can be obtained. In addition, according to Embodiment 2, it is possible to dispose the neighboring connection wiring lines in different layers and to dispose the neighboring first input terminal and second input terminal in the same layer. Thus, no stepped portion is formed between the neighboring input terminals, and the shapes of the input pads for connection to the driving IC chip 11 can be uniformized. Therefore, a defect in connection of the driving IC chip 11 can be prevented.

Furthermore, the neighboring first connection wiring line and second connection wiring line are disposed in different layers, and the same number of jumper sections are provided between the input sections and the scan lines. Specifically, the first connection wiring line 51 has the second jumper section J2 between the input section 40Y and the scan line Y. The second connection wiring line 52 has the first jumper section J1 between the input section 40Y and the scan line Y. Thus, even if the jumper section is formed of a material with a relatively high resistance, the wiring resistance due to the presence of the jumper section can be made substantially uniform between the neighboring connection wiring lines. Therefore, it is possible to suppress the influence on the display quality due to the driving signals from the respective connection wiring lines.

The first and second jumper sections can be formed in the same step using the same material. Thus, no additional fabrication step for forming the jumper section is needless.

### Embodiment 3

In Embodiment 3, the structural parts common to those in Embodiment 1 and Embodiment 2 are denoted by like reference numerals, and a detailed description thereof is omitted.

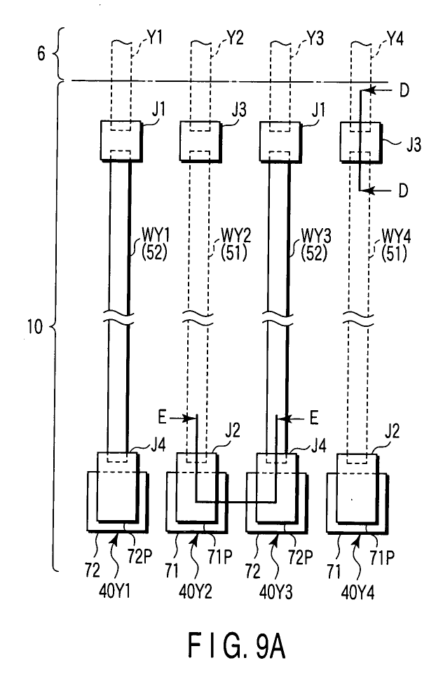

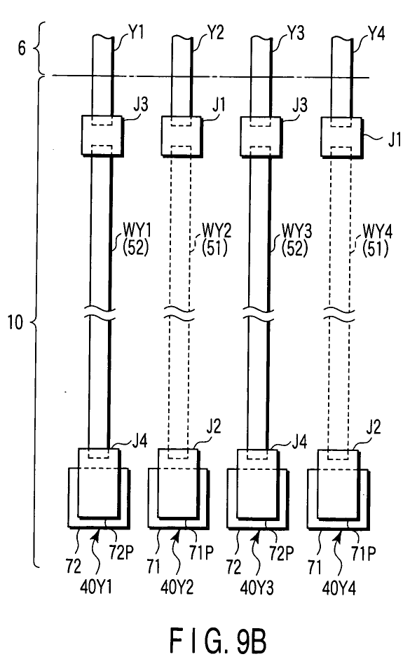

As is shown in FIG. 9A, scan lines Y (1, 2, 3, . . . ) are disposed in the active area 6. The input sections 40Y (1, 2, 3, . . . ) and the connection wiring lines WY (1, 2, 3, . . . ), which connect the scan lines Y and the associated input sections 40Y, are disposed in the outer peripheral part 10. In the example shown in FIG. 9A, even-numbered connection wiring lines WY (2, 4, . . . ) are disposed in the same layer as the scan lines Y, and correspond to the first connection wiring lines 51 shown in FIG. 3. Odd-numbered connection wiring lines WY (1, 3, . . . ) are disposed in a layer different from the layer of the scan lines Y, and correspond to the second connection wiring lines 52 shown in FIG. 3. In short, the even-numbered connection wiring lines WY (2, 4, . . . ) and the odd-numbered connection wiring lines WY (1, 3, . . . ), which neighbor the even-numbered connection wiring lines WY (2, 4, . . . ), are disposed in different layers.

The first connection wiring lines 51 are electrically connected via third jumper sections J3 to the associated scan lines Y that are disposed in the same layer. On the other hand, the second connection wiring lines 52 are electrically connected via first jumper sections J1 to the associated scan lines Y that are disposed in the different layer. The connection structure between the second connection wiring line 52 and the associated scan line Y via the first jumper section J1 is the same as shown in FIG. 5.

As is shown in FIG. 10, the third jumper section J3 is disposed on the second insulation layer 62. The third jumper section J3 is electrically connected to the first connection wiring line 51 via a second contact hole H2 that penetrates the first insulation layer 61 and second insulation layer 62 down to the first connection wiring line 51, and is also connected to the scan line Y via a second contact hole H2 that penetrates the first insulation layer 61 and second insulation layer 62 down to the scan line Y. The third jumper section J3 can be formed at the same time in the step of forming the metal pattern in the active area 6. For example, the third jumper section J3 can be formed of the same material as the pixel electrode 8. Thus, no additional fabrication step is required to form the third jumper section J3.

The input section 40Y (2, 4, . . . ) that corresponds to the first connection wiring line 51 includes a first input terminal 71 that is disposed in a layer different from the layer of the first connection wiring line 51 and is connected to the first connection wiring line 51 via a second jumper section J2. The input section 40Y (1, 3, . . . ) that corresponds to the second connection wiring line 52 includes a second input terminal 72 that is disposed in the same layer as the second connection wiring line 52 and is connected to the second connection wiring line 52 via a fourth jumper section J4. The first input terminal 71 and second input terminal 72 that form the input sections 40Y can be formed in the same step using the same metal material. In this example, the first input terminal 71 and second input terminal 72 are formed at the same time as the second connection wiring line 52. In short, the first input terminal 71 and second input terminal 72 are disposed in the same layer.

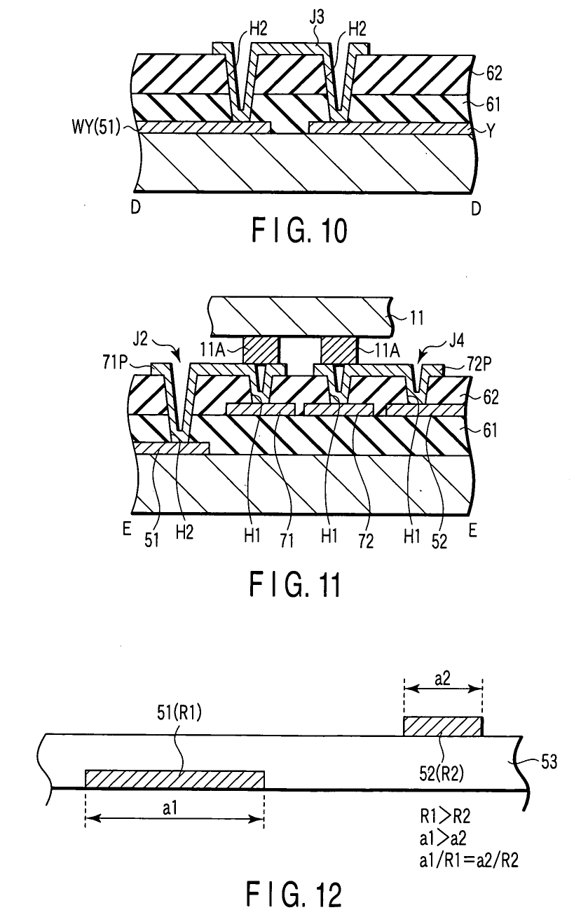

The input sections 40Y (1, 2, 3, 4, . . . ) include a plurality of input pads that are connected to output terminals 11A of the driving IC chip 11. Specifically, as shown in FIG. 11, the input section 40Y (2, 4, . . . ) that corresponds to the first connection wiring line 51 includes an input pad 71P. The input pad 71P is electrically connected to the first connection wiring line 51 via a second contact hole H2 that penetrates the first insulation layer 61 and second insulation layer 62 down to the first connection wiring line 51, and is also electrically connected to the first input terminal 71 via a first contact hole Hi that penetrates the second insulation layer 62 down to the first input terminal 71. In this case, the input pad 71P also functions as the second jumper section J2.

On the other hand, the input section 40Y (1, 3, . . . ) that corresponds to the second connection wiring line 52 includes an input pad 72P. The input pad 72P is electrically connected to the second connection wiring line 52 via a first contact hole H1 that penetrates the second insulation layer 62 down to the second connection wiring line 52, and is also connected to the second input terminal 72 via a first contact hole H1 that penetrates the second insulation layer 62 down to the second input terminal 72. In this case, the input pad 72P also functions as the fourth jumper section J4.

The input pads 71P and 72P can be formed at the same time in the step of forming the metal pattern in the active area 6. For example, the input pads 71P and 72P can be formed of the same material as the pixel electrode 8.

Thereby, driving signals, which are output from the output terminals 11A of the driving IC chip 11, can be supplied to the first connection wiring line 51 via the input section 40Y including the input pad 71P and first input terminal 71, and to the second connection wiring line 52 via the input section 40Y including the input pad 72P and second input terminal 72.

According to the above-described Embodiment 3, the same advantageous effects as with Embodiment 2 are obtained.

In addition, the neighboring first connection wiring line and second connection wiring line are disposed in different layers, and have the same number of jumper sections between the input sections and the scan lines. Specifically, the first connection wiring line 51 has the second jumper section J2 and third jumper section J3 between the input section 40Y and the scan line Y. The second connection wiring line 52 has the fourth jumper section J4 and first jumper section J1 between the input section 40Y and the scan line Y. Thus, even if the jumper section is formed of a material with a relatively high resistance, the wiring resistance due to the presence of the jumper section can be made substantially uniform between the neighboring connection wiring lines. Therefore, it is possible to suppress the influence on the display quality due to the driving signals from the respective connection wiring lines.

The first to fourth jumper sections can be formed in the same step using the same material. Thus, no additional fabrication step for forming the jumper section is needless.

In the above-described Embodiment 3, the third jumper section J3 and fourth jumper section J4 connect the wiring lines that are disposed in the same layer or connect the wiring line and input terminal that are disposed in the same layer, and thus they function as dummy jumper sections. There is a case where the connection wiring lines have different lengths between the associated input sections and scan lines. In this case, by adjusting the resistance values of the dummy jumper sections, the difference in resistance between the connection wiring lines can be made closer to zero. In addition, with the provision of the dummy jumper sections, it is possible to uniformize the layers in which the input terminals and scan lines are disposed. In other words, the dummy jumper sections have layer-replacement functions. Hence, as shown in FIG. 9B, it is possible to dispose all the input terminals and all the scan lines in the same layer.

In the above-described Embodiments 1 to 3, it is not always possible to form the neighboring first connection wiring line 51 and second connection wiring line 52 of the same material. Assume now that the first connection wiring line 51 is formed in the same step as the scan line Y and that the material of the first connection wiring line 51 and the scan line Y has a sheet resistance R1. In addition, assume that the second connection wiring line 52 is formed in the same step as the signal line X and that the material of the second connection wiring line 52 and the signal line X has a sheet resistance R2. If the first connection wiring line 51 and the second connection wiring line 52 are formed with the same line width, a difference in resistance would occur between the wiring lines.

To deal with this problem, as illustrated in FIG. 12, the ratio (a1/R1) of the line width al to the sheet resistance R1 of the first connection wiring line 51 is set to be substantially equal to the ratio (a2/R2) of the line width a2 to the sheet resistance R2 of the second connection wiring line 52. Since the sheet resistance of each material is a characteristic value, the line width of each connection wiring line may be adjusted in accordance with the sheet resistance. Thereby, the difference in resistance between the wiring lines can be made closer to zero.

As has been described above, according the display device of the embodiment, of a plurality of connection wiring lines disposed on the outer peripheral part of the active area, mutually neighboring connection wiring lines are disposed in different layers. Thereby, it becomes possible to reduce the size of the outer peripheral part (i.e. reduction in size of the picture-frame-shaped region) and to increase the density of connection wiring lines disposed in the outer peripheral part (i.e. increase in wiring density). Even in the case where the reduction in size of the picture-frame-shaped region and the increase in wiring density are achieved, it is possible to secure the adequate line width of each wiring line and the sufficient gaps between wiring lines, to prevent occurrence of defects in a reliability test and to improve manufacturing yield.

The present invention is not limited to the above-described embodiments. In practice, the structural elements can be modified without departing from the spirit of the invention. Various inventions can be made by properly combining the structural elements disclosed in the embodiments. For example, some structural elements may be omitted from all the structural elements disclosed in the embodiments. Furthermore, structural elements in different embodiments may properly be combined.

For example, the display device of the present invention is not limited to the above-described liquid crystal display device, and may be another type of display device such as an organic electroluminescence display device including self-luminous elements as display elements.

In the above-described embodiments, the signal supply wiring lines have been described as being scan lines. However, the signal supply wiring lines may be signal lines, and may include other wiring lines disposed on the outer peripheral part of the array substrate. The signal supply source has been described as being a driving IC chip that is mounted on the array substrate. However, in the case of the structure wherein the driving IC chip 11 is not directly mounted on the liquid crystal display panel 1, for example, in the case of the structure wherein the signal supply source is provided on a flexible printed circuit (FPC) that is connected to the second connection section 32, input sections in the second connection section may have structures as described in connection with the embodiments.

In the above-described Embodiments 2 and 3, the even-numbered connection wiring lines WY (2, 4, . . . ) correspond to the first connection wiring lines 51 that are disposed in the same layer as the scan lines Y, and the odd-numbered connection wiring lines WY (1, 3, . . . ) correspond to the second connection wiring lines 52 that are disposed in the layer different from the layer of the scan lines Y. Alternatively, the even-numbered connection wiring lines WY (2, 4, . . . ) may correspond to the second connection wiring lines 52 that are disposed in the layer different from the layer of the scan lines Y, and the odd-numbered connection wiring lines WY (1, 3, . . . ) may correspond to the first connection wiring lines 51 that are disposed in the same layer as the scan lines Y.

Besides, in the above-described Embodiments 2 and 3, the input section 40Y (2, 4, . . . ) that corresponds to the first connection wiring line 51 includes the first input terminal 71 that is disposed in the layer different from the layer of the first connection wiring line 51, and the input section 40Y (1, 3, . . . ) that corresponds to the second connection wiring line 52 includes the second input terminal 72 that is disposed in the same layer as the second connection wiring line 52. However, the relationship between the layers in which the connection wiring lines and input sections are disposed is not limited to this example. The input section 40Y (2, 4, . . . ) may include the first input terminal 71 that is disposed in the same layer as the first connection wiring line 51, and the input section 40Y (1, 3, . . . ) may include the second input terminal 72 that is disposed in the layer different from the layer of the second connection wiring line 52. Further, these input sections may be disposed in a layer different from the layers of the first connection wiring line 51 and second connection wiring line 52.

What is claimed is:

1. A display device comprising:
an active area that is composed of a plurality of pixels and a plurality of signal supply wiring lines that supply driving signals to the pixels;
a plurality of input sections that are disposed outside the active area and function to input the driving signals that are to be supplied to the signal supply wiring lines; and
a plurality of connection wiring lines that connect the signal supply wiring lines and the input sections,
wherein mutually neighboring first connection wiring line and second connection wiring line of the connection wiring lines are disposed in different layers via an insulating layer.

2. The display device according to claim 1, wherein the first connection wiring line is disposed in the same layer as the signal supply wiring line and is connected to the signal supply wiring line, and
the second connection wiring line is disposed in a layer different from the layer of the signal supply wiring line and is connected to the signal supply wiring line via a jumper section.

3. The display device according to claim 1, wherein the first connection wiring line is disposed in the same layer as the signal supply wiring line and is connected to the signal supply wiring line via a jumper section, and
the second connection wiring line is disposed in a layer different from the layer of the signal supply wiring line and is connected to the signal supply wiring line via a jumper section.

4. The display device according to claim 1, wherein the input sections include a first input terminal that is disposed in the same layer as the first connection wiring line and is connected to the first connection wiring line, and a second input terminal that is disposed in the same layer as the second connection wiring line and is connected to the second connection wiring line.

5. The display device according to claim 1, wherein the input sections include a first input terminal that is disposed in a layer different from the layer of the first connection wiring line and is connected to the first connection wiring line via a jumper section, and a second input terminal that is disposed in the same layer as the second connection wiring line and is connected to the second connection wiring line.

6. The display device according to claim 1, wherein the input sections include a first input terminal that is disposed in a layer different from the layer of the first connection wiring line and is connected to the first connection wiring line via a jumper section, and a second input terminal that is disposed in the same layer as the second connection wiring line and is connected to the second connection wiring line via a jumper section.

7. The display device according to claim 1, wherein the first connection wiring line and the second connection wiring line are connected between the input sections and the signal supply wiring lines via the same number of jumper sections.

8. The display device according to claim 7, wherein the jumper sections are formed of the same material.

9. The display device according to claim 7, wherein the active area includes pixel electrodes that are disposed in the respective pixels, and
the jumper sections are formed of the same material as the pixel electrodes.

10. The display device according to claim 1, wherein a ratio of a line width to a sheet resistance of the first connection wiring line is substantially equal to a ratio of a line width to a sheet resistance of the second connection wiring line.

11. The display device according to claim 1, wherein the input sections include input pads that are connected to output terminals of a signal supply source that supplies the driving signals to the signal supply wiring lines.

12. The display device according to claim 1, wherein the signal supply wiring lines include a plurality of scan lines that extend along rows of the pixels, and a plurality of signal lines that extend along columns of the pixels in a layer different from a layer of the scan lines, and
the first connection wiring line is disposed in the same layer as the signal line, and the second connection wiring line is disposed in the same layer as the scan line.
